(19) United States
(12) Patent Application Publication
(10) Pub. No.: US 2014/0279770 A1
(43) Pub. Date: Sep. 18, 2014

(54) ARTIFICIAL NEURAL NETWORK INTERFACE AND METHODS OF TRAINING THE SAME FOR VARIOUS USE CASES

(71) Applicant: REMTCS Inc., Red Bank, NJ (US)

(72) Inventors: Tommy Xaypanya, Lamar, MS (US); Richard E. Malinowski, Colts Neck, NJ (US)

(73) Assignee: REMTCS Inc., Red Bank, NJ (US)

(21) Appl. No.: 14/199,917

(22) Filed: Mar. 6, 2014

Related U.S. Application Data
(60) Provisional application No. 61/794,430, filed on Mar. 15, 2013.
(60) Provisional application No. 61/794,472, filed on Mar. 15, 2013.
(60) Provisional application No. 61/794,505, filed on Mar. 15, 2013.
(60) Provisional application No. 61/794,547, filed on Mar. 15, 2013.
(60) Provisional application No. 61/891,598, filed on Oct. 16, 2013.
(60) Provisional application No. 61/897,745, filed on Oct. 30, 2013.
(60) Provisional application No. 61/901,269, filed on Nov. 7, 2013.

(51) Int. Cl. G06N 3/02

(52) U.S. Cl. CPC G06N 3/02
USPC 706/15

(57) ABSTRACT

An Artificial Neural Network Interface (ANNI) is disclosed along with use cases for the same. The ANNI utilizes one or more decision trees and/or probabilistic/combinatoric analysis to determine optimal responses to current conditions. The ANNI is also enabled to learn new conditions that are accepted as normal and, in response thereto, update the decision tree(s).

### CROSS-REFERENCE TO RELATED APPLICATIONS

The present application claims the benefit of U.S. Provisional Patent Application Nos. 61/794,430, 61/794,472, 61/794,505, 61/794,547, 61/891,598, 61/897,745, and 61/901,269, filed on Mar. 15, 2013, Mar. 15, 2013, Mar. 15, 2013, Mar. 15, 2013, Oct. 16, 2013, Oct. 30, 2013, and Nov. 7, 2013, respectively, each of which are hereby incorporated herein by reference in their entirety.

### FIELD OF THE DISCLOSURE

The present disclosure is generally directed to artificial intelligence systems and methods of implementing the same.

### BACKGROUND

Artificial intelligence (AI) is the intelligence exhibited by machines or software, and the branch of computer science that develops machines and software with intelligence. Because most AI systems are inherently complex, it is generally true that AI systems are not quickly trained (e.g., the models of the AI system often take a significant amount of time to build and re-build).

### SUMMARY

It is, therefore, one aspect of the present disclosure to provide an artificial neural network interface (ANNI) and mechanisms for training the same. In some embodiments, the disclosed ANNI can be utilized in a number of different scenarios: homeland security, human health analysis (e.g., by receiving inputs from body sensors and optimizing treating options), market trading (e.g., by receiving market inputs and picking various different algorithms to trade with given current and predicted future market conditions), military front of the wire analysis, network forensics, etc.), cyber security, and so on.

In some embodiments, the disclosed ANNI is capable of determining a contextual meaning of users verses datasets within environments containing encrypted and/or unencrypted data. In particular, ANNI's A.I. initial function or intelligent logic command is to primarily identify all digital assets and compare datasets found historically in activity logs and concurrently present in real time within a newly introduced environment then create multiple semantic groups or databases of each digital asset into similar patterns/data structures.

With an environment that contains encrypted data, ANNI is capable of collecting all encrypted datasets, metadata, any historical digital footprint available to give meaning to “why, how, what, who, from, how long, when?” into its own query database for analysis and regression after ANNI locates, identifies, then finds context of all normal data.

After ANNI allocates all encrypted digital data from normal, unencrypted data, ANNI begins the contextual correlation and regresses each piece of data through global identifier engines to understand the “why, how, what, who, from, how long, when?” of all normal data within the environment.

When the A.I. finishes categorizing the learning model elements that give meaning to why normal data exists within the environment, coupled with the completion of digital profiles for each normal occurring dataset, ANNI then compares the user's historical interaction with the current real time data. ANNI creates a normal regression model to compute the meaning process of all encrypted data.

The effort to identify and understand encrypted data does not require or call for the decryption of all encrypted data beforehand. ANNI correlates then regresses how encryption data is “used, created, sent, etc.” into prediction models to understand the difference between how encrypted data should be handled from historical data found (e.g., for clustering, etc.). Based simply on user interaction information (e.g., use information for encrypted data such as when it was used, modified, created, sent, to whom it was sent, from whom it was sent, etc.) the AI can use the normal data context model to regress for abnormal encrypted datasets.

The datasets that have very few occurrences of how the environment/users conduct encryption gets flagged for decryption and further investigation.

In summary, ANNI does not require decryption of the entire collection of encrypted datasets within an environment. After ANNI utilizes regressive context learning of the normal data, user interaction is then correlated for meaning, ANNI then searches for what the “Normal conduct” should be for the encryption patterns. ANNI can identify encrypted data anomalies then send an alert to the administrator for review or submit to a High-Performance Computer (HPC) for automated brute force decryption for a best practice evaluation of the data.

In some embodiments, a learning framework is provided in which data mining operations are performed to determine conditions and analyze all possible outcomes from those conditions. The learning system and method, as disclosed herein, provides the ability to mine data from virtually any source, develop a decision tree based on predicted, most probable, least probable, etc. outcomes and then utilize the decision tree for analyzing decision options to the problem. It can be appreciated that the use-cases for such a system are virtually limitless. Some non-limiting examples of use cases for an ANNI as disclosed herein include the following:
Macted ANNI—Military ANNI that can be used as a correlation engine to solve immediate military issues: ANNI would be used to create a decision tree to predict future occurrences
ANNI Drone—The ability to review Geospatial changes in topography to see if any changes are occurring. ANNI would be placed in a drone, flying over a geography to see if anyone is digging holes, creating major changes in topography, earth movements and in real time (within 40 microseconds start to relay this information back to HQ).
Blue on Green—ANNI would be used to predict the occurrences of Afgani soldiers attacking US/NATO troops. This system can be used to identify the characteristics of a successful attack.
In Front of the Wire—This implementation of ANNI predicts when an attack will occur on a forward base.
ANNI Health—The ability to receive inputs from bio-sensors (e.g., EKG machines, blood pressure, temperature, etc.) and mine the data from the bio-sensors to develop treatment options (e.g., a decision tree with treatment options based on conditions of the human body) and further determine the best treatment option for the patient based on current and predicted body conditions
An artificial intelligence solution that monitors for malicious activity & potential hardware modifications to the vehicle in real time. It can automate/control you car data response features, monitor & access your mobile network from your mobile device to vehicle, detect malicious patterns in vehicle as well digital data processing from user devices to the car's CPU.
ANNI Financials—A combinatoric model that picks the most profitable trade to make at any given time based on current market conditions and makes the trade. This implementation of ANNI may specifically provide the ability to switch from one trading algorithm to another trading algorithm as market conditions develop. For instance, the decision tree and the analysis of the current market conditions may dictate that the trading algorithm should switch from a volume trading algorithm to a volatility trading algorithm or a hedge model as market conditions evolve.
ANNI Forensics—An implementation of ANNI for forensics purposes (e.g., network forensics)

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Also, while the disclosure is described in terms of exemplary embodiments, it should be appreciated that individual aspects of the disclosure can be separately claimed. The present disclosure will be further understood from the drawings and the following detailed description. Although this description sets forth specific details, it is understood that certain embodiments of the disclosure may be practiced without these specific details. It is also understood that in some instances, well-known circuits, components and techniques have not been shown in detail in order to avoid obscuring the understanding of the invention

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The present disclosure is described in conjunction with the appended figures:

FIG. 1 is a block diagram depicting an intelligent computing system in accordance with embodiments of the present disclosure;

FIG. 2 is a block diagram depicting a base algorithm for rule creation in accordance with embodiments of the present disclosure;

FIG. 3 is a block diagram depicting a framework for updating ANNI in accordance with embodiments of the present disclosure;

FIG. 4 is a flow diagram depicting a statistical database creation algorithm in accordance with embodiments of the present disclosure; and

FIG. 5 is a block diagram depicting a behavioral detection model in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Referring initially to FIG. 1, a system 100 is depicted as including one or more computational components that can be used in conjunction with an AI system. More specifically, the intelligent computing system 100 is depicted as including a communication network 104 that connects a computing device 108 to one or more data sources 128 and one or more consumer devices 132.

In accordance with at least some embodiments, the computing device 108 may comprise a processor 116 and memory 112. The processor 116 may be configured to execute instructions stored in memory 112. Illustrative examples of instructions that may be stored in memory 112 and, therefore, be executed by processor 116 include ANNI 120 and a communication module 124.

The communication network 104 may correspond to any network or collection of networks (e.g., computing networks, communication networks, etc.) configured to enable communications via packets (e.g., an Internet Protocol (IP) network). In some embodiments, the communication network 104 includes one or more of a Local Area Network (LAN), a Personal Area Network (PAN), a Wide Area Network (WAN), Storage Area Network (SAN), backbone network, Enterprise Private Network, Virtual Network, Virtual Private Network (VPN), an overlay network, a Voice over IP (VoIP) network, combinations thereof, or the like.

The computing device 108 may correspond to a server, a collection of servers, a collection of mobile computing devices, personal computers, smart phones, blades in a server, etc. The computing device is connected to a communication network 104 and, therefore, may also be considered a networked computing device. The computing device 108 may comprise a network interface or multiple network interfaces that enable the computing device 108 to communicate across various types of communication networks. For instance, the computing device 108 may include a Network Interface Card, an antenna, an antenna driver, an Ethernet port, or the like. Other examples of computing devices 108 include, without limitation, laptops, tablets, cellular phones, Personal Digital Assistants (PDAs), thin clients, super computers, servers, proxy servers, communication switches, Set Top Boxes (STBs), smart TVs, etc.

As noted above, other embodiments of the computing device 108 may correspond to a server or the like. When implemented as a server, the computing device 108 may correspond to a physical computer (e.g., a computer hardware system) dedicated to run or execute one or more services as a host. In other words, the server may serve the needs of users of other computers or computing devices connected to the communication network 104. Depending on the computing service that it offers, the server implementation of the computing device 108 could be a database server, file server, mail server, print server, web server, gaming server, or some other kind of server.

The memory 112 may correspond to any type of non-transitory computer-readable medium. Suitable examples of memory 112 include both volatile and non-volatile storage media. Even more specific examples of memory 112 include, without limitation, Random Access Memory (RAM), Dynamic RAM (DRAM), Static RAM (SRAM), Flash memory, Read-Only Memory (ROM), Programmable ROM (PROM), Erasable PROM (EPROM), Electronically Erasable PROM (EEPROM), virtual memory, variants thereof, extensions thereto, combinations thereof, and the like. In other words, any type of electronic data storage medium or combination of storage media may be used without departing from the scope of the present disclosure.

The processor 116 may correspond to a general purpose programmable processor or controller for executing programming or instructions stored in memory 112. In some embodiments, the processor 116 may include one or multiple processor cores and/or virtual processors. In other embodiments, the processor 116 may comprise a plurality of separate physical processors configured for parallel or serial processing. In still other embodiments, the processor 116 may comprise a specially configured Application Specific Integrated Circuit (ASIC) or other integrated circuit, a digital signal processor, a controller, a hardwired electronic or logic circuit, a programmable logic device or gate array, a special purpose computer, or the like. While the processor 116 may be configured to run programming code contained within memory 112, such as ANNI 120, the processor 116 may also be configured to execute other functions of the computing device 108 such as an operating system, one or more applications, communication functions, and the like.

ANNI 120 may comprise the quickly and efficiently learn and apply new learning models to any number of problems or fields of use. In particular, ANNI 120 may comprise a learning framework in which data mining operations are performed to determine conditions and analyze all possible outcomes from those conditions. The learning system and method, as disclosed herein, provides the ability to mine data from virtually any source, develop a decision tree based on predicted, most probable, least probable, etc. outcomes and then utilize the decision tree for analyzing decision options to the problem. It can be appreciated that the use-cases for such a system are virtually limitless. Some non-limiting examples of use cases for an ANNI 120 as disclosed herein include the following:
Macted ANNI—Military ANNI that can be used as a correlation engine to solve immediate military issues: ANNI would be used to create a decision tree to predict future occurrences
ANNI Drone—The ability to review Geospatial changes in topography to see if any changes are occurring. ANNI would be placed in a drone, flying over a geography to see if anyone is digging holes, creating major changes in topography, earth movements and in real time (within 40 microseconds start to relay this information back to HQ).
Blue on Green—ANNI would be used to predict the occurrences of Afgani soldiers attacking US/NATO troops. This system can be used to identify the characteristics of a successful attack.
In Front of the Wire—This implementation of ANNI predicts when an attack will occur on a forward base.
ANNI Health—The ability to receive inputs from bio-sensors (e.g., EKG machines, blood pressure, temperature, etc.) and mine the data from the bio-sensors to develop treatment options (e.g., a decision tree with treatment options based on conditions of the human body) and further determine the best treatment option for the patient based on current and predicted body conditions
Anni Drive—An artificial intelligence solution that monitors for malicious activity & potential hardware modifications to the vehicle in real time. It can automate/control you car data response features, monitor & access your mobile network from your mobile device to vehicle, detect malicious patterns in vehicle as well digital data processing from user devices to the car's CPU.
ANNI Financials—A combinatoric model that picks the most profitable trade to make at any given time based on current market conditions and makes the trade. This implementation of ANNI may specifically provide the ability to switch from one trading algorithm to another trading algorithm as market conditions develop. For instance, the decision tree and the analysis of the current market conditions may dictate that the trading algorithm should switch from a volume trading algorithm to a volatility trading algorithm or a hedge model as market conditions evolve.
ANNI Forensics—An implementation of ANNI for forensics purposes (e.g., network forensics)

In some embodiments, ANNI 120 may be configured to receive and process data from the one or more data sources 128 and then, based on its continuously updated learning models, provide data outputs to one or more consumer devices 132. It should be further appreciated that the data source(s) 128 may be the same as the consumer devices 132, although this is not a requirement.

The communication module 124 may comprise any hardware device or combination of hardware devices that enable the computing device 108 to communicate with other devices via a communication network. In some embodiments, the communication module 124 may comprise a network interface card, a communication port (e.g., an Ethernet port, RS232 port, etc.), one or more antennas for enabling wireless communications, one or more drivers for the components of the interface, and the like. The communication module 124 may also comprise the ability to modulate/demodulate, encrypt/unencrypt, etc. communication packets received at the computing device 108 from a communication network and/or being transmitted by the computing device 108 over the communication network 104. The communication module 124 may enable communications via any number of known or yet to be developed communication protocols. Examples of such protocols that may be supported by the communication module 124 include, without limitation, GSM, CDMA, FDMA, and/or analog cellular telephony transceiver capable of supporting voice, multimedia and/or data transfers over a cellular network. Alternatively or in addition, the communication module 124 may support IP-based communications over a packet-based network, Wi-Fi, BLUETOOTH™, WiMax, infrared, or other wireless communications links.

With reference now to FIG. 2, an illustrative process for building and updating rule sets within ANNI 120 will be described in accordance with embodiments of the present disclosure. The process begins when audit data 204 is detected by a data sniffer 208 of ANNI 120. The sniffer 208 may be searching streams of data from the data sources 128 to determine if data of interest or anomalous data has been received at the computing device 108. When the sniffer 208 detects data of interest or anomalous data (e.g., data not matching or fitting within an already developed rule set or model), the sniffer 208 provides the received audit data 204 to a genetic algorithm 212.

In some embodiments, the genetic algorithm 212 is configured to process and analyze the audit data 204 received via sniffer 208. More specifically, the genetic algorithm 212 may enable ANNI 120 to generate and represent a statistical output decision according to the following where y and x={x1, . . . , xn} are values used to find or identify anomalous behavior that can eventually be used to build or update rule sets 216. Specifically, ANNI 120 may find anomalous behavior F*(x) that maps x to y, such that over the joint distribution of all (y, x)-values, the expected value of some specified loss function Ψ(y, F(x)) is minimized:

F(x)=arg minF(x)Ey,xΨ(y,F(x)).

Boosting approximates F*(x) by an additive expansion of the form:

$$F ( x ) = {\sum }_{m = 0}^{M} {β}_{m} h ( x ; {a}_{m} ) ,$$

Where the functions h(x; a) (base learner) are set by the framework to be simple functions of x with parameters a={a1, a2, . . . . am}. The expansion coefficients {βₘ}₀^{M} and the parameters {αₘ}₀^{M} are made fit to the training data in a forward stage-wise manner. The genetic algorithm 212 starts with an initial guess F₀ (x) and then for m=1, 2, . . . , M

(βₘ,αₘ)=argmin Σᵢ₌₁^{β,α}Ψ(yᵢ,Fₘ_{_{—}}₁(xᵢ)+βh(xᵢ;a))

and

Fₘ(x)=Fₘ₋₁(x)+βₘh(x;aₘ)

Based on the above analysis, the genetic algorithm 212 may generate or modify one or more rule sets 216, which can then be stored in a database 220 or similar computer memory location for later reference ANNI 120.

In some embodiments, ANNI 120 is radically different from any other forms of neural networks or artificial intelligences. In particular, ANNI 120 does not have any neural structures pre-defined by the user. ANNI's 232 neural network(s) resembles neurological structures where connections between the nodes are autonomic—forming without conscious control.

Connections from an n-dimensional graph that describes all relationships between every byte that has been fed into the system. This enables ANNI 120 to learn at the find of data ingestion—automatically adjusting relationships to account for new data.

As it learns, ANNI 120 creates a minimal ontology that automatically classifies each byte into a hierarchy by topic—staring with the most general then progressively moving to most specific. An unlimited number of hierarchies can form in any direction—forming a heterarchy. (Hierarchical classifications are arranged by hyponymy.) ANNI 120 may detect an inherent semantic meaning of each byte as it relates to another—there is no human bias or over-learning. This minimal ontology approach enables the machine to learn high-order relationships between any data elements. Said another way, ANNI 120 can detect the conceptual meaning of words and isolate when a word is used in an unexpected or unique way.

ANNI 120 also offers users the option to teach the system, giving the machine an intentional point of view. Searches can be input to the minimal ontology that dynamically adjust the topography of the data to influence the importance of data elements to specific relationships. Enabling the system to learn the best path to answer a problem. If the problem is repeated, ANNI 120 may tighten the association among the relevant data elements that form the answer. Like muscle memory in humans.

Different from neutral nets, ANNI 120 reveals all relationships that comprise the answer to a problem. Semi-transparency. Teachable—commands within SDK allows users to instruct ANNI 120 to make specific association and ignore others. Directing ANNI 120 to external resources or global servers to learn patterns is recommended and potentially faster. In particular, ANNI 120 is both language and data agnostic and is configured to learn at the byte level. Context or ANNI's learn database datasets require that substantial tinkering occur by activating or deactivating parts of ANNI's neural model, without altering the actual code. For example within the 64 bit Linux micro-kernel, which at boot time discovers what CPU it is running on, and actually disables parts of its binary code in case (for example) it is running on a single CPU system. This goes beyond something like if (numcpus >1), it is the actual nopping out of locking. Crucially, this nopping occurs in memory and not on the disk based image. ANNI's context database is stored like RLL or MFM coding. On a hard disk, a bit is encoded by a polarity transition or the lack thereof. A naive encoding would encode a 0 as ‘no transition’ and 1 as ‘a transition’. Encoding 000000—keeps the magnetic phase unchanged for a few micrometers. During decoding, to understand exact micrometers, data is treated that long stretches of no transitions do not occur. If ANNI observes ‘no transition, no transition, transition, transition’ on disk, ANNI can determine that the context DNA byte corresponds to ‘0011’—it is exceedingly unlikely that ANNI's reading process is so imprecise that this might correspond to ‘00011’ or ‘00111’. So the system is developed to insert spacers so to prevent too little transitions. This is called ‘Run Length Limiting’ on magnetic media. Transitions need to be inserted to make sure that the data can be stored reliably. ANNI's learning context cell or datasets cannot clone unless very stringent conditions are met—a ‘secure by default’ configuration.

With reference now to FIG. 3, a framework for updating ANNI 120 will be described in accordance with embodiments of the present disclosure. The framework includes initial audit data 304 that is provided to a profile 308 in steps S301 and S302. In particular, the initial audit data may have a genetic algorithm applied thereto to optimize fuzzy-membership function parameters (step S301) and fuzzy association rule mining may be provided to the profile 308 (step S302). The profile 308, based on the information received from the initial audit data 304, may be compared to rules mined from an incremental part a current time window 312 (step S303). Based on the comparison, ANNI 120 will determine whether the similarity of the profile 308 is above or below a predetermined similarity threshold. If the similarity is above the predetermined similarity threshold, then the profile 308 is not updated (step S304). On the other hand, if the similarity goes below the predetermined similarity threshold, then one of two actions may occur. First, if the similarity goes below the similarity threshold with a change greater than a predetermined delta (e.g., signifying a sharp change), then an anomalous data instance form the audit data 304 is identified for the profile 308 (step S304). On the other hand, if the similarity goes below the similarity threshold with a change less than a predetermined delta (e.g., signifying a gradual change), then the profile 308 is updated to create an updated profile 316 (step S306). The updated profile 316 may then be stored in lieu of the profile (step S308) or in addition to storing the original profile 308 (step S309). Furthermore, the information related to the audit data in the current time window (e.g., last 100 ms) may be stored along with the updated profile 316 to help provide a context for the profile update (step S307).

FIG. 4 depicts further details of the AI framework that may be implemented by ANNI 120 or any other component of the proactive security mechanism 108. Specifically, ANNI 120 may implement a three-anomaly detection technique. The first anomaly may correspond to a Fuzzy Clustering Algorithm (fuzzy logic)+data mining which is used to determine automated intrusion detection. The second anomaly may utilize Feature Set Reduction with a J48 decision tree machine learning or neural networks. The third anomaly may utilize decision tree machine learning and Support Vector Machine.

As shown in FIG. 4, genetic algorithms could be used to tune the fuzzy membership function parameters. A fuzzy c-medoids algorithm may be used to select random medoid candidates (step 404), allocate each point to the closest medoid (step 408), calculate new medoids (step 412), allocate each point to closest medoid (step 416), determine whether an object is to be moved (step 420) and, if not generate cluster data (step 424). The cluster data can then be stored in local storage (step 428) and/or a datastore (step 432).

Data mining techniques may be used. Data mining techniques basically correspond to pattern discovery algorithms, but most of them are drawn from related fields like machine learning or pattern recognition. In context to intrusion detection following data mining techniques, one or more of the following techniques may be utilized in accordance with embodiments of the present disclosure: (1) Association rules—defines the normal activity by determining attribute correlation or relationships among items in dataset which makes discovery of anomalies becomes easy; (2) Frequent Episode rules—describes the audit data relationship using the occurrence of the data; (3) Classification—classifies the data into one of the available categories of data as either normal data or one of the types of attacks; (4) Clustering—clusters the data into groups with the property of inter-group similarity and intra-group dissimilarity; and (5) Characterization—differentiates the data, further used for deviation analysis.

With reference now to FIG. 5, details of an illustrative behavioral detection model will be described in accordance with embodiments of the present disclosure. The model includes an event generator 504, which may correspond to an audit trail, network packets, application trails, etc. As events occur at the event generator 504, rule sets 512 may be modified, created, and/or updated as per FIGS. 2 and/or 4 (step S503). Likewise, the generation of events may also result in the modification, creation, and/or updating of activity profiles 508 as per FIG. 3 (step S504). Moreover, the updating of rule sets 512 may result in the updating or creation of new activity profiles 508 (step S501) and as activity profiles are created, modified, etc., anomaly records may be created within the rule sets 512 (step S502).

In some embodiments, some or all of the steps of the behavioral detection model may be executed at every clock cycle as determined by control of clock 516. Thus, ANNI 120 is configured to constantly and continuously learn and retrain its profiles and rule sets every clock cycle instead of waiting for other events or external triggers. This creates a quicker and more efficient mechanism for computer learning.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
mining data related to conditions and variables of one or more events;
based on the mined data, creating a decision tree that includes options for responding to each of the one or more events and probabilities of success for each of the options; and
using an artificial intelligence agent to traverse the decision tree and, based on current conditions, determine, from the decision tree, a computer-selected optimal option for responding to the current conditions.

2. The method of claim 1, wherein the one or more events correspond to at least one of military events, health-related events, and network events.

3. The method of claim 1, further comprising:
providing the information related to the one or more events to a genetic algorithm;
processing the information related to the one or more events with the genetic algorithm; and
determining, based on the processing of the one or more events with the genetic algorithm, whether to at least one of create and modify a rule set; and
storing the rule set in a database.

4. The method of claim 3, wherein processing the information related to the one or more events with the genetic algorithm comprises:
searching for anomalous behavior F*(x) that maps x to y, such that over a joint distribution of all (y, x) values, an expected value of a specified loss function is minimized.

5. The method of claim 4, wherein the specific loss function comprises: arg minF(x) E y,x Ψ(y, F(x)).

6. The method of claim 5, wherein boosting approximates F*(x) by an additive expansion of the form: F(x)=Σₘ₌₀^{M}βₘh(x; aₘ), wherein the functions h(x; a) correspond to base learner functions that are set by functions of x with parameters a={a1, a2, . . . , am}, and wherein expansion coefficients {βₘ}₀^{M} and the parameters {αₘ}₀^{M} are made fit to the training data in a forward stage-wise manner.

7. The method of claim 1, wherein the artificial intelligence agent is both language and data agnostic and learns at the byte level.

8. A non-transitory computer-readable medium comprising processor-executable instructions that, when executed by a processor, perform a method, the method comprising:
mining data related to conditions and variables of one or more events;
based on the mined data, creating a decision tree that includes options for responding to each of the one or more events and probabilities of success for each of the options; and
using an artificial intelligence agent to traverse the decision tree and, based on current conditions, determine, from the decision tree, a computer-selected optimal option for responding to the current conditions.

9. The computer-readable medium of claim 8, wherein the one or more events correspond to at least one of military events, health-related events, and network events.

10. The computer-readable medium of claim 8, wherein the method further comprises:
providing the information related to the one or more events to a genetic algorithm;
processing the information related to the one or more events with the genetic algorithm; and
determining, based on the processing of the one or more events with the genetic algorithm, whether to at least one of create and modify a rule set; and
storing the rule set in a database.

11. The computer-readable medium of claim 10, wherein processing the information related to the one or more events with the genetic algorithm comprises:
searching for anomalous behavior F*(x) that maps x to y, such that over a joint distribution of all (y, x) values, an expected value of a specified loss function is minimized.

12. The computer-readable medium of claim 11, wherein the specific loss function comprises: arg minF(x) E y,x Ψ(y, F(x)).

13. The computer-readable medium of claim 12, wherein boosting approximates F*(x) by an additive expansion of the form: F(x)=Σₘ₌₀^{M}βₘh(x; aₘ), wherein the functions h(x; a) correspond to base learner functions that are set by functions of x with parameters a={a1, a2, . . . , am}, and wherein expansion coefficients {βₘ}₀^{M} and the parameters {αₘ}₀^{M} are made fit to the training data in a forward stage-wise manner.

14. The computer-readable medium of claim 8, wherein the artificial intelligence agent is both language and data agnostic and learns at the byte level.

15. A computing device, comprising:
computer memory having instructions stored thereon, the instructions including an artificial neural network interface that is configured, when executed, to mine data related to conditions and variables of one or more events, based on the mined data, create a decision tree that includes options for responding to each of the one or more events and probabilities of success for each of the options, and then traverse the decision tree to automatically select an optimal option for responding to the current conditions; and
a processor configured to read the instructions stored in the memory and execute the instructions including the artificial neural network interface.

16. The computing device of claim 15, wherein the one or more events correspond to at least one of military events, health-related events, and network events.

17. The computing device of claim 15, wherein the artificial neural network interface is further configured, when executed by the processor, to process the information related to the one or more events with the genetic algorithm.

18. The computing device of claim 17, wherein the genetic algorithm searches for anomalous behavior F*(x) that maps x to y, such that over a joint distribution of all (y, x) values, an expected value of a specified loss function is minimized.

19. The computing device of claim 18, wherein the specific loss function comprises: arg minF(x) E y,x Ψ(y, F(x)), wherein boosting approximates F*(x) by an additive expansion of the form: F(x)=Σₘ₌₀^{M}βₘh(x; aₘ), wherein the functions h(x; a) correspond to base learner functions that are set by functions of x with parameters a={a1, a2, . . . , am}, and wherein expansion coefficients {βₘ}₀^{M} and the parameters {αₘ}₀^{M} are made fit to the training data in a forward stage-wise manner.

20. The computing device of claim 15, wherein the artificial neural network interface is both language and data agnostic and learns at the byte level.
